(19) United States
(12) Patent Application Publication
(10) Pub. No.: US 2017/0030553 A1
(43) Pub. Date: Feb. 2, 2017

(54) Lighting System that Reduces Environmental Light Pollution

(71) Applicant: LED Living Technology, Inc., Bristol, PA (US)

(72) Inventors: Oliver Szeto, Bristol, PA (US); Kevin High, Bristol, PA (US); Adam Gernerd, Bristol, PA (US)

(73) Assignee: LED Living Technology, Inc.

(21) Appl. No.: 15/224,506

(22) Filed: Jul. 29, 2016

Related U.S. Application Data
(60) Provisional application No. 62/199,946, filed on Jul. 31, 2015.

(51) Int. Cl. F21V 9/00

(52) U.S. Cl. CPC F21V 9/00; F21Y 2115/10

(57) ABSTRACT

A lighting fixture that minimizes light pollution in the blue frequencies of the visible spectrum. The lighting fixture contains a plurality of LEDs in an array. The array emits light with a first spectral profile. Most of the LEDs in the array have a correlated color temperature of between 2200K and 6500K, with a preferred value under 5000K. The light from the array passes through a filter. The filter removes much of the fractals of light between 400 nm and 500 nm so that the fractals between 400 nm and 500 nm account for no more than two percent of the overall intensity of the light. However, the filter decreases the intensity of light between 550 nm and 750 nm by no more than ten percent. This produces a light fixture that is highly energy efficient, has a high CRI index, and emits very low levels of light in the blue wavelengths of the spectrum.

### RELATED APPLICATIONS

This application claims priority of provisional patent application No, 62/199,946, filed Jul. 31, 2015.

### BACKGROUND OF THE INVENTION

1. Field of the Invention

In general, the present invention relates to filtered light systems that emit light only in a specified band of wavelengths. More particularly, the present invention relates to lighting systems for providing indoor and outdoor ambient lighting in areas of the country where light pollution requires control, such as areas near astronomical telescopes and areas with light-reactive nocturnal wildlife.

2. Prior Art Description

Light Pollution, also known as photo-pollution or luminous pollution, is excessive, misdirected, or obtrusive artificial light that causes degradation in the natural photonic habitat. Light pollution is a side effect of industrial civilization. The primary sources of light pollution include exterior lighting, escaping interior lighting, illuminated advertising, illuminated traffic signs, parking lot lights, headlights, factory lighting, streetlights, and illuminated sporting venues. As man-made light enters the environment, it diffuses into the surrounding area, therein brightening the surrounding area. As manmade light reflects skyward, the light creates a phenomenon called sky glow.

Sky glow is the diffused glow that can be seen over populated areas. It arises from light reflected from illuminated surfaces and from light escaping directly upward from incompletely shielded or upward-directed light fixtures. The light is then scattered by the atmosphere back toward the ground. The brightness of sky glow is affected strongly by the amount of light used, the orientation of the light sources and the color or spectral content of the light sources. The scatter of light is increased by optical phenomenon, such as Rayleigh scattering and the Purkinje effect. Because of the eye's increased sensitivity to blue light when adapted to very low luminance levels, light with blue hews contribute significantly more to sky glow than do equivalent light sources that produce light with hews outside the blue wavelengths.

Sky glow is of particular irritation to astronomers and others who want to observe the stars in the night sky. Sky glow brightness is typically measured using the Bortle Dark-Sky Scale. The Bortle Dark-Sky Scale rates the darkness of the night sky and the visibility of its contents, such as the Milky Way.

There are many powerful astronomical telescopes positioned around the world. These telescopes gather and focus light from the night sky. As such, the quality of the images observed by the telescopes are directly related to the quality of the light received by the telescopes. Light from sky glow is perceived as noise by the telescope, wherein the sky glow degrades the light incoming from above. Due to these circumstances, the many municipalities around astronomical telescopes have passed ordinances that limit the type of light that can be viewed outside at night. Typically, the ordinances require that light be filtered in the wavelengths in and around the blue wavelengths of the visible spectrum, which are the wavelengths disproportionately responsible for increased sky glow.

To meet the lighting ordinances, many people and companies may just filter white light by placing a blue light filter over the white light. This is an inefficient solution because it takes electrical power to produce light. If a significant part of the light being produced is absorbed by a filter, then much of the light energy is lost. Thus, the power consumption of the light is large in proportion to the light it emits. The light, therefore, becomes very inefficient for the amount of light that it produces. Furthermore, the absorbed light often manifests as heat. The temperature of the light fixture, therefore, increases. This can reduce the efficiency of the light and can cause other problems, such as accelerated filter degradation and insect attraction.

Another prior art solution is to produce colored light outside the blue wavelengths, such as with sodium vapor lamps, that produce light with little or no blue wavelength components. The problem with such colored light is that it is washed out natural color. The Color Rendering Index (CRI) of a light source is the ability of the light source to accurately reproduce the colors of an object as perceived by a person's eye. Colors themselves are nothing more than a light source generating certain wavelengths of light, which is then reflected off an object and back to the eye, which is then interpreted by the brain as color. If the wavelength is not being emitted by the light source itself, it therefore cannot be reflected back to the viewer. This hinders the ability to perceive the color of the object accurately. If all items are bathed in shades of the same color, a person at night has difficulty perceiving the color differences that the eye uses to define the borders of objects. Consequently, many people lose depth perception or are otherwise discomforted by the light.

Merely producing a matrix of LEDs that do not contain any blue frequency LEDs seems like a simple solution to reducing light pollution. However, it does not work. LED's have a significant advantage in CRI levels as compared to many other light sources, such as low pressure sodium, metal halide, and even some fluorescent technologies. By eliminating LEDs that produce light in the blue spectrum, much of the advantages, in regard to CRI levels, are lost.

Additionally, an array of LEDs is far more energy efficient than most other popular lighting technologies. Filtering the blue spectrum from an array of LEDs with a traditional blue light filter significantly hinders this advantage. The filter is effectively blocking light in a particular wavelength in which the LED light source delivers much of the light. Consequently, most of the light is filtered away and more power is needed to pass light through the filter.

A need therefore exists for a lighting system that efficiently produces light with a high color rendering index, yet with very low levels of blue light. In this manner, the lights can be used in areas sensitive to light pollution without wasting power and without washing out natural colors. This need is met by the present invention as described below.

### SUMMARY OF THE INVENTION

The present invention is a lighting fixture that minimizes light pollution in the blue frequencies of the visible spectrum. The lighting fixture contains a plurality of LEDs in an array. The array emits light with a first spectral profile. Most of the LEDs in the array have a correlated color temperature of between 2200K and 6500K, with a preferred value under 5000K.

The light from the array passes through a filter. The filter removes much of the fractals of light between 400 nm and 500 nm so that the fractals between 400 nm and 500 nm account for no more than two percent of the overall intensity of the light. However, the filter decreases the intensity of light between 550 nm and 750 nm by no more than ten percent. This produces a light fixture that is highly energy efficient, has a high CRI index, and emits very low levels of light in the blue wavelengths of the spectrum. Such lights are highly useful in areas where light pollution is to be controlled.

### BRIEF DESCRIPTION OF THE DRAWINGS

For a better understanding of the present invention, reference is made to the following description of an exemplary embodiment thereof, considered in conjunction with the accompanying drawings, in which:

FIG. 1 is a fragmented perspective view of an exemplary embodiment of a light fixture;

FIG. 2 is a side cross-sectional view of the exemplary embodiment of FIG. 1;

FIG. 3 is a table that shows compliance of different filter panels with Equation 1 of the specification:

FIG. 4 is a graph that shows the wavelength emissions of a first LED array, before and after filtering, in the exemplary embodiment of the light fixture;

FIG. 5 is a graph that shows the wavelength emissions of a second LED array, before and after filtering, in the exemplary embodiment of the light fixture;

FIG. 6 is a graph that shows the wavelength emissions of a third LED array, before and after filtering, in the exemplary embodiment of the light fixture.

### DETAILED DESCRIPTION OF THE DRAWINGS

Although the present invention lighting system can be embodied in most any lighting fixture, the embodiment illustrated shows a simple lighting fixture for the purposes of illustration and description. The illustrated embodiment sets forth one of the best modes contemplated for the invention. The illustrated embodiment, however, is merely exemplary and should not be considered a limitation when interpreting the scope of the appended claims.

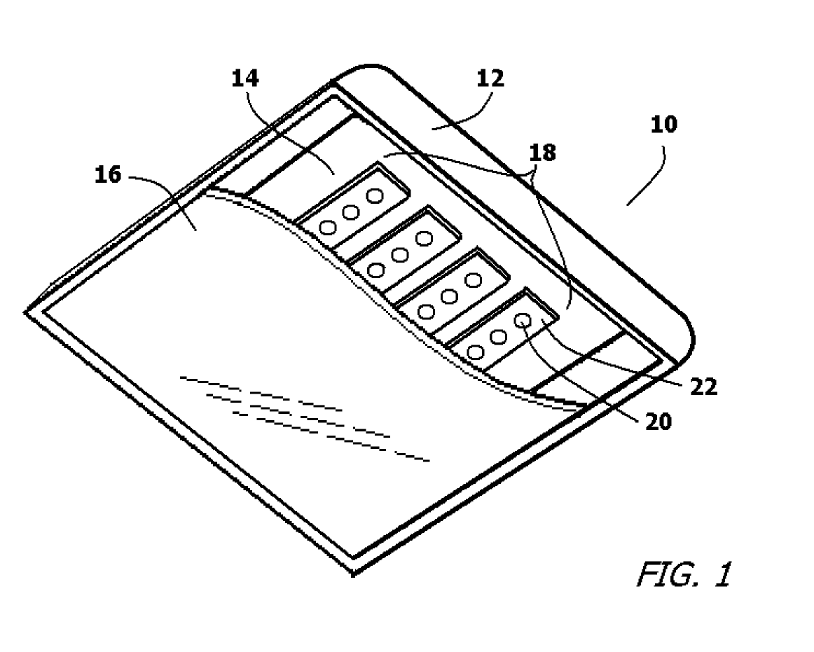

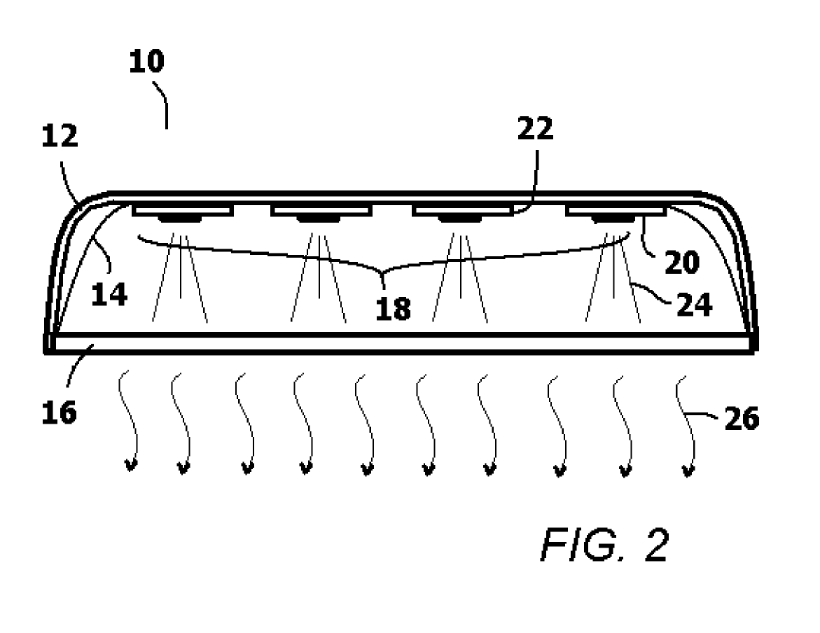

Referring to FIG. 1 in conjunction with FIG. 2, a light fixture 10 is shown. The light fixture 10 has a housing 12. The housing 12 can have any shape, as dictated by the lighting need being served. It will therefore be understood that the shown embodiment of the housing 12 is a simple example.

Within the housing 12 is often a reflector 14, or a reflective troffer surface, that assists in directing light through a front filter panel 16. The light is generated by an array 18 of LEDs 20. The array 18 of LEDs 20 is comprised of one or more circuit boards 22 that are mounted to the troffer 14 within the housing 12. As will be explained, the individual LEDs 20 in each array 18 are provided in a variety of colors and Correlated Cold Temperature (CCT) values. The LEDs 20 in each array 18, therefore, produce light at various wavelengths in the visible spectrum up to 780 nm. However, the array 18 of LEDs 20 is specially designed to emit very little light between the light frequencies in the blue region of the visible spectrum between 400 nm and 500 nm.

More specifically, the LEDs 20 in the array 18 are specifically designed to emit light 24 in a first spectral profile. As the emitted light 24 from the array 18 passes through the filter panel 16, the first spectral profile is altered into light 26 of a filtered second spectral profile. The LEDs 20 in the array 18 and the filter panel 16 are designed to conform to a specific control algorithm. As is indicated below by Equation 1, the control algorithm requires that the sum of the fractal light intensity in the targeted blue wavelengths (400 nm-500 nm) divided by the light intensity of the full spectrum range of the light fixture 10 (380 nm-780 mn) be less than 2%.

$$\frac{\begin{matrix}Intensity of Blue \\ Wavelengths ( 400 nm \text{-} 500 nm )\end{matrix}}{\begin{matrix}Intensity of All \\ Wavelengths ( 380 nm \text{-} 780 nm )\end{matrix} } < 2 \% \qquad ( Equation 1 )$$

In other words, less than 2% of the light 26 emitted by the light fixture 10 will fall in the 400 nm-500 nm range of the visible spectrum. Yet, the other light outside of this range will approach the color profile of natural light or white light.

The first step in providing the light fixture 10 with a proper spectral profile is to select the proper LEDs 20 in the array 18. LEDs 20 have Correlated Color Temperatures (CCT) that are used to define the color tone of the LEDs 20. The color tone is the perceived color of the light source itself. The closer the color tone is to red, the warmer the color temperature. Conversely, the closer the color tone is to blue, the cooler the color temperature. Red tone LEDs have a CCT near 1000K. White tone LEDs have a CCT near 4500K. LEDs with dark blue tones have a CCT near 10,000K. By way of reference, a CCT of 2700K is comparable to a typical incandescent light bulb.

In the present invention, LEDs 20 with CCT values of between 2200K-6500K are preferred. Such LEDs are inherently shifted away from blue. Much of the blue spectrum is eliminated by selecting the LEDs 20 of the proper color tone. If done correctly, very little of the light emitted by the LEDs 20 needs to be removed. The LEDs 20 used in the array 18 must also have a high Color Rendering Index (CRI). In this manner, the LEDs 20 provide a wide spectrum of light and prevent light that shades objects in hews of the same color. An exemplary list of preferred LEDs is shown below in Table 1.

TABLE 1

| LED CCT Value | LED CRI Value |
|---|---|
| 2200 K | 80+ |
| 3000 K | 90+ |
| 3500 K | 80+ |
| 4000 K | 70+ |
| 4000 K | 80+ |
| 4500 K | 70+ |
| 4500 K | 80+ |
| 5000 K | 70+ |
| 6500 K | 65+ |

It will be understood that Table 1 has only some examples and that other LED types within the shown range of CCT values (2200K-6000K), and a CRI value over 65. A preferred range includes LEDS 20 with a CCT value of between 2500K-5000K and with a CRI value of 70+ or greater. The LEDs 20 in the array 18 can be mixture of LEDs with different CCT values and/or CRI values. The LEDs selected in the mix should emit light primarily between 500 nm and 700 nm. Ultraviolet LEDs can be used that emit light under 400 nm. However, in most applications, the use of ultraviolet LEDs is unnecessary. A few wide spectrum white LEDs can also be included within each array 18. However, the number of white LEDs is kept low so that any blue light component emitted by the white LEDs amounts to less than 2% of the total light emitted by the array 18.

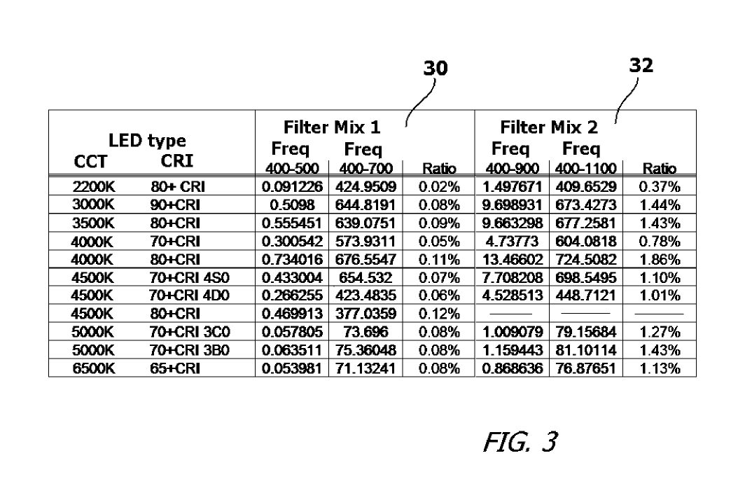

Once the LEDs 20 for the array 18 are selected, the second step is to provide the filter panel 16. The light 24 produced by the array 18 of LEDs 22 passes through a specialized filter panel 16 before it is emitted into the ambient environment. The specialized filter panel 16 is a plastic panel that is infused with a unique combination of compounds that selectively filter blue light without significantly degrading the output levels of other color frequencies. The filter panel 16 is an L60175 panel, or equivalent panel, that is infused with Solvent Yellow 114 dye, Quinolone dye, and 2-(3-hydroxy-2-quinolyl)-1H-indene-1,3(2H)-dione, which has the Chemical Abstracts Service (CAS) number of 7576-65-0. The concentration of the 2-(3-hydroxy-2-quinolyl)-1H-indene-1, 3(2H)-dione ranges from 0.3%-1.0% depending upon the thickness of the filter panel 16 required by the lighting fixture 10. As presented in FIG. 3, two exemplary formulations (Mix 1 & Mix 2) for the filter panel 16 are described. The first formulation 30 uses the above formulation with a 2-(3-hydroxy-2-quinolyl)-1H-indene-1,3(2H)-dione concentration near the low end of the range (0.3%). The second formulation 32 uses the same formulation with a 2-(3-hydroxy-2-quinolyl)-1H-indene-1, 3(2H)-dione concentration near the high end of the range (1.0%).

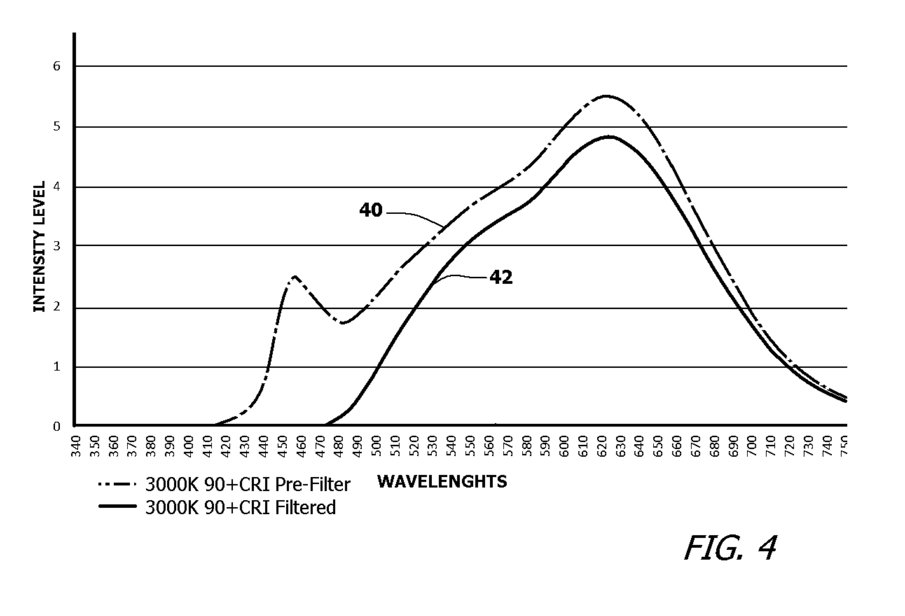

Using the formulations for the filter panel 16 shown in FIG. 3, a filter panel 16 is created that efficiently filters blue light without significant absorption of other wavelengths. Absorption of light between 550 nm and 750 nm remains well under ten percent. Referring now to FIG. 4 in conjunction with FIG. 1 and FIG. 2, a first example is shown for an array 18 of LEDs 20, wherein the LEDs 20 have a 3000K CCT value and a 90+ CRI value. The array 18 produces a first spectral light profile, as indicated by line 40. The first spectral light profile shows a small peak of light intensity about 450 nm. The light produced by the array 18 passes through the filter panel 16, wherein the light conforms to a filtered second spectral light profile. The filtered second spectral light profile is shown by line 42. As can be seen, the filter panel 16 eliminates nearly all the light between 400 nm and 480 nm. Light intensity between 480 nm and 500 nm is minimal. The spectral light profile between 500 nm and 750 nm is essentially unaltered, except for a slight decrease in intensity.

The light in the blue region of the spectrum is highly suppressed. However, light from the green-to-red areas of the spectrum approach the profile of unfiltered light. Since the light is full bodied from green-to-red, the resulting light has a high color rending index. As a result, at night, the light 26 emitted by the lighting assembly 10 enables people to readily perceive and differentiate colors. Furthermore, very little of the light that is produced by the LED arrays 18 is lost to filtering. The result is a light assembly 10 that is highly efficient and does not have a hot filter plate. Consequently, the light assembly 10 can be operated in an economical fashion without heat degradation to the filter.

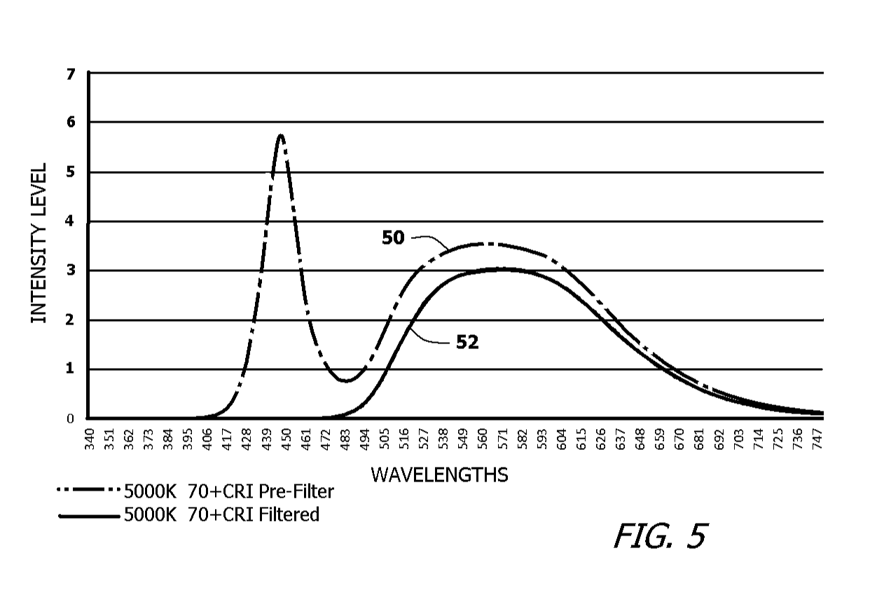

Referring to FIG. 5 in conjunction with FIG. 1 and FIG. 2, a second example is shown for an array 18 of LEDs 20, wherein the LEDs 20 have a 5000K CCT value and a 70+ CRI value. The array 20 produces a first spectral profile, as indicated by line 50. The first spectral profile shows a large peak of light intensity about 440 nm. The light produced by the array 18 passes through the filter panel 16, wherein the light conforms to a filtered second spectral profile. The filtered second spectral profile is shown by line 52. As can be seen, the filter panel 16 eliminates nearly all the light between 400 nm and 483 nm. Light intensity between 483 nm and 500 nm is minimal. The spectral profile between 500 nm and 750 nm is essentially unaltered, except for a slight decrease in intensity.

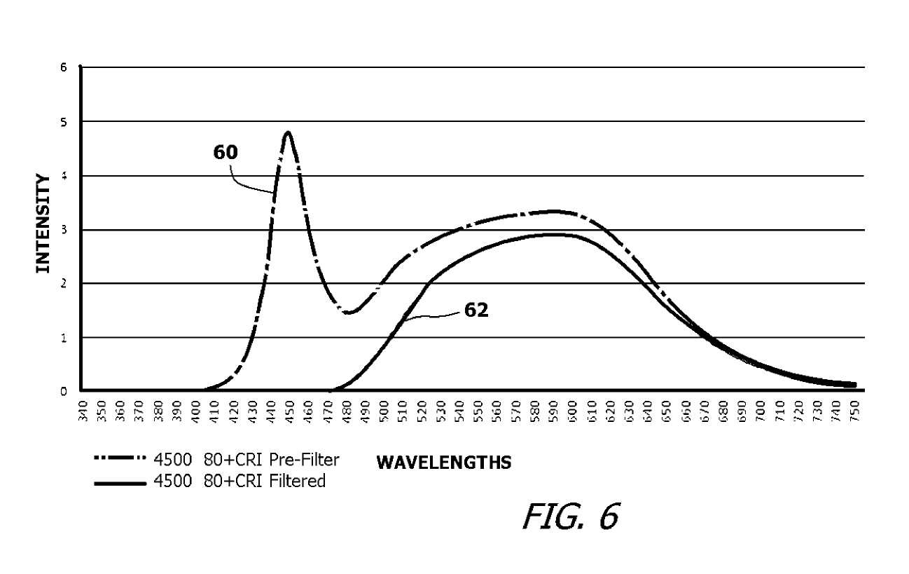

Referring to FIG. 6 in conjunction with FIG. 1 and FIG. 2, a third example is shown for an array 18 of LEDs 20, wherein the LEDs 20 have a 4500K CCT value and an 80+ CRI value. The array 20 produces a first spectral profile, as indicated by line 60. The first spectral profile shows a large peak of light intensity about 450 nm. The light produced by the array 18 passes through the filter panel 16, wherein the light conforms to a filtered second spectral profile. The filtered second spectral profile is shown by line 62. As can be seen, the filter panel 16 eliminates nearly all the light between 400 nm and 480 nm. Light intensity between 480 nm and 500 nm is minimal. The spectral profile between 500 nm and 750 nm is essentially unaltered, except for a slight decrease in intensity.

Using the LEDs 20 and the filter panel 16 as described, a light fixture 10 is produced that is highly energy efficient, has a high CRI index and emits very low levels of light in the blue regions of the spectrum. Such lights are highly useful in areas where light pollution is controlled.

It will be understood that the embodiment of the light fixture that is illustrated and described is merely exemplary and that a person skilled in the art can create many alternate embodiments. Changes to the number of LEDs, the position of the LEDs, the shape of the housing and the shape of the reflector should be considered design options that are intended to be included in the scope of the claims.

What is claimed is:

1. A lighting fixture, comprising:
a plurality of LEDs in an array, wherein said array emits light with a first spectral profile, wherein most of said LEDs in said array have a correlated color temperature of between 2200K and 6500K;
a filter designed to primarily filter a blue light range between 400 nm and 500 nm, wherein said filter is mounted proximate said array and said light in said first spectral profile passes through said filter, therein producing filtered light in a second spectral profile.

2. The lighting fixture according to claim 1, wherein said light with said first spectral profile is emitted at a first intensity by said LEDs in said array.

3. The lighting fixture according to claim 2, wherein said filtered light with said second spectral profile has a second intensity.

4. The lighting fixture according to claim 3, wherein said light with said first spectral profile includes some fractal of light in said blue light range between 400 nm and 500 nm, wherein said fractal of light passes through said filter panel at a third intensity.

5. The lighting fixture according to claim 4, wherein said third intensity of said fractal of light in said blue light range between 400 nm and 500 nm is less than two percent of said second intensity of said second spectral profile.

6. The lighting fixture according to claim 1, wherein said LEDs in said array have a color rendering index of at least 65.

7. The lighting fixture according to claim 1, wherein said filter is a plastic panel infused with between, 0.3% an 1.0% of 2-(3-hydroxy-2-quinolyl)-1H-indene-1, 3(2H)-dione, which has the Chemical Abstracts Service (CAS) number of 7576-65-0.

8. The lighting fixture according to claim 7, wherein said filter is further infused with Solvent Yellow 114 dye and a Quinolone dye.

9. The lighting fixture according to claim 1, wherein said filter diminishes said first intensity of said first spectral profile by no greater than ten percent in the frequency range of 550 nm-750 nm.

10. A lighting fixture, comprising:
a plurality of LEDs in an array, wherein said array emits light with a first spectral profile, wherein most of said LEDs in said array have a correlated color temperature of between 2200K and 5000K; and
a filter, wherein said first spectral profile passes through said filter, therein producing filtered light in a second spectral profile, wherein said second spectral profile contains less than two percent of light between 400 nm and 500 nm.

11. The lighting fixture according to claim 10, wherein said light with said first spectral profile is emitted at a first intensity by said LEDs in said array.

12. The lighting fixture according to claim 11, wherein said filtered light with said second spectral profile of has a second intensity.

13. The lighting fixture according to claim 12, wherein said light with said first spectral profile includes some fractal of light in said blue light range between 400 nm and 500 nm, wherein said fractal of light passes through said filter at a third intensity.

14. The lighting fixture according to claim 13, wherein said third intensity of said fractal of light in said blue light range between 400 nm and 500 nm is less than two percent of said second intensity of said second spectral profile.

15. The lighting fixture according to claim 10, wherein said LEDs in said array have a color rendering index of at least 65.

16. The lighting fixture according to claim 10, wherein said filter is a plastic panel infused with between, 0.3% an 1.0% of 2-(3-hydroxy-2-quinolyl)-1H-indene-1, 3(2H)-dione, which has the Chemical Abstracts Service (CAS) number of 7576-65-0.

17. The lighting fixture according to claim 16, wherein said filter is further infused with Solvent Yellow 114 dye and a Quinolone dye.

18. The lighting fixture according to claim 10, wherein said filter diminishes said first intensity of said first spectral profile by no greater than ten percent in the frequency range of 550 nm-750 nm.
